(19) United States
(12) Patent Application Publication
(10) Pub. No.: US 2024/0084147 A1
(43) Pub. Date: Mar. 14, 2024

(54) WATER-BASED ACRYLIC LATEX PAINT TRANSMISSIVE IN THE NIR AND SWIR BANDS

(71) Applicant: Raytheon Company, Waltham, MA (US)

(72) Inventors: Haralambos Cordatos, Colcheste, CT (US); Jose-Rodrigo Castillo-Garza, West Hartford, CT (US)

(21) Appl. No.: 17/932,094

(22) Filed: Sep. 14, 2022

(51) Int. Cl. C09D 5/02; C09D 7/43; C09D 113/02

(52) U.S. Cl. CPC C09D 5/027; C09D 7/43; C09D 113/02

(57) ABSTRACT

A water-based acrylic latex paint has a dispersant-over-pigment (DOP) ratio between 0.5 and 1.5 to form a coating in which the pigment has a low concentration and is highly dispersed throughout to absorb in the visible band to produce a color (e.g., black) and is transmissive in the NIR and SWIR bands. The variables that determine absorption in the visible band and transmission in the NIR and SWIR bands include the DOP ratio, a pigment weight percentage between 1-2% in the paint and a coating thickness between 2 and 4 mil. To control the viscosity, the dispersing agent is suitably an acrylate-based block co-polymer, of molecular weight above 2,000 grams per mole, that includes an amine-functional block to anchor onto the pigment.

### BACKGROUND

### Field

This disclosure relates to coatings that absorb in the visible band and transmit in the near infrared (NIR) and short-wave infrared (SWIR) bands.

### Description of the Related Art

Spectral coatings provide specified transmittance, reflectance or absorption in different bands of the electro-magnetic spectrum. One particular class of coatings provides high absorption in the visible band and high transmissivity in the NIR and SWIR bands. The Visible band spans approximately 400-700 nm. As used herein, the NIR band spans 800-1300 nm and the SWIR band spans 1300-2200 nm. The coatings may be formed from plastics or paint that include SWIR transmissive pigments or dyes or structural layers such as nanofeatures and interference layers or multi-layer films. The coatings may be used, for example, to cover or obscure in an aesthetic manner some type of IR body or device such as an IR Transmit/Receive sensor (Lidar in a car or IR communication on portable devices), solar cells on buildings, or a reflective surface as part of a Cool Coating on a building. The coating provides a color, typically black, that hides what is behind the coating.

US Publication 2021/0096288 entitled “Infrared Transmissive Product” published Apr. 1, 2021 discloses a black layer including a coating film layer that is formed by combining a transparent plastic and at least two types of dyes/pigments that have an infrared transmissivity and produce a black color when mixed together. The black layer has a thickness in a range from 5 microns to 50 microns (0.2 to 2 mil). The black layer contains 50 to 150 parts by mass of dyes/pigments as a whole in relation to 100 parts by mass of transparent plastic.

U.S. Pat. No. 7,727,418 entitled “Infrared Transmissive Thermoplastic Composition and Articles Formed Therefrom” issued Jun. 1, 2010 discloses a thermoplastic composition comprising a thermoplastic polymer, and a dye combination comprising a black dye, and a fluorescent dye, wherein a molded article having a thickness of 2.0 millimeters and consisting of the thermoplastic polymer, the black dye, and the fluorescent dye, has a percent transmission of infrared light according to ASTM D1003-00 of greater than or equal to 50%, when measured at a wavelength of 800 to 1,100 nm, and a percent transmission of visible light, according to ASTM D1003-00 of less than or equal to 15%, when measured at a wavelength of 400 to 650 nm.

Roof coatings are used, in part, to reflect electromagnetic energy to keep a building cool. However, the coolest white roof coatings desired to reflect in the Visible and NIR/SWIR bands are often not accepted by homeowners with visible roofs for aesthetic reasons. Black coatings, which are more aesthetically acceptable, must absorb practically all of the visible band to provide a black appearance. In addition, standard black coatings absorb in the NIR and SWIR bands, greatly raising the roof surface temperature. One approach is to provide a black spectral coating that is reflective in the NIR and SWIR bands. Another approach is to provide a black spectral coating that is transmissive in the NIR and SWIR bands that is positioned over a white coating or an aluminum alloy that reflect in the NIR and SWIR bands. Incident IR radiation passes through the coating and is reflected off of the white coating/aluminum alloy back through the coating instead of being absorbed.

Tore Kolas et. al., “Cool coatings with high near infrared transmittance for coil coated aluminum”, Solar Energy Materials and Solar Cell 196 (2019) 94-104. As described at section 2.3, “Each formulation included the major four prime components in a coating: pigment (NIR-transparent), organic polymer (high durable commercially available polyester), organic solvents and additives (defoameter and dispersion additive). Catalyst and cross link additives were already included in the commerically produced polymer. In one formulation, the pigment was BASF Paliogen Black S0084 at a weight percent of 5%. The formulations were applied to pre-treated Al sheets with an average dry film thickness (DFT) of about 20 μm (0.8 mil) and cured in an oven with heated air at 232 degrees Celsius to cross-link the polymer bonds.

Jie Qin et. al., “The Optical Properties of Black Coatings and Their Estimated Cooling Effect and Cooling Energy Savings”, Journal of Power and Energy Engineering, 2014, 2, 68-75 disclose a formulation for a cool black coating including a pure acrylic emulsion, a black pigment, an extender pigment such as Talcum that is transparent and non-reflective throughout the visible and NIR/SWIR bands and other appropriate paint additives such as a wetting agent, a dispersant, an anti-foaming agent, a leveling agent and a coalescent. To prepare the cool black coatings, the acrylic emulsion and talcum were first added into the mixing setup, followed by the addition of the wetting agent, dispersant and leveling agent. The mixture was stirred and then a prefabricated black pigment dispersion was pumped into the paint mixing setup and stirred. Water was added to adjust the viscosity of the coatings. The cool black coatings were applied with a thickness of 100 to 150 microns (4-6 mil) to a bare aluminum alloy substrate. As shown in Table 1, the black pigment, talcum and dispersant have weight % of 5.0, 25.0 and 0.5 respectively. Based only on the black pigment, the dispersant-over-pigment (DOP) ratio is 0.1. This ratio produces a relatively high concentration of pigment in the coating.

Based on the application for cool coatings, the critical parameter is not transmittance of the coating in the NIR/SWIR band but is the total reflectance off of the cool black coating and the aluminum alloy/reflective base coat. This coating may achieve the total reflectance through a combination of direct reflectance off of the cool black coating and transmittance through the coating and reflectance off of the alloy or base coat. This may have the beneficial effect of reducing the transmittance specifications of the coating in the NIR and SWIR bands.

US Publication 2021/0096288 mentions at para [0005] formation of the black layer by applying a paint made of a single black pigment such as carbon black or Ketjen black. However, the light transmissivity rises in a section of the wavelength region of visible light rays that is slightly lower than the boundary with the wavelength region of infrared rays. This suggests that a paint containing a single black pigment does not provide adequate absorption in the visible band for a NIR/SWIR transparent coating.

### SUMMARY

The present specification discloses a water-based acrylic latex paint having a dispersant-over-pigment (DOP) ratio between 0.5 and 1.5 to form a coating in which the pigment has a low concentration and is highly dispersed throughout to absorb in the visible band to produce a color (e.g., black) and is transmissive in the NIR and SWIR bands.

In an embodiment, the variables that determine absorption in the visible band and transmission in the NIR and SWIR bands include the DOP ratio between 0.5 and 1.5, a weight percentage of the pigment between 1-2% wt. in the paint formulation and a thickness of the coating between 2 and 4 mil. More typically, the DOP ratio is between 0.8 and 1.5.

In an embodiment in which the visible band spans 300-700 nm, the NIR band spans 800-1300 nm and the SWIR band spans 1300-2200 nm, the coating has an average transmittance of less than 20% over the visible band and average transmittances greater than 60% transmissive over the NIR band and greater than 80% transmissive over the SWIR band. Preferably, the transmittance specification is satisfied at each wavelength within the bands. An exemplary formulation that meets these specifications includes a binder of RHOPLEX™ AC-261F, a pigment of Paliogen® Black L0086 and a dispersing agent is EFKA® PX4310 in which the DOP ratio is approximately 1 and that coating dries with a thickness of 2.5 mil with a black color.

In an embodiment, the pigment is selected to provide a cut-off wavelength between the visible and NIR bands. A single pigment may be used to provide a “black” color with the requisite spectral properties. Additional pigments may be included to provide non-black colors although this may reduce the transmissivity in the NTR and SWIR bands.

In an embodiment, to control the viscosity of the pre-mixture, the dispersing agent is a high molecular weight compound of over 2,000 grams per mole. The dispersing agent suitably includes an acrylic-based block co-polymer including an amine-functional block to anchor onto the pigment.

In an embodiment, the rheology modifier is selected to provide “associative thickening” to the paint. The rheology modifier suitably includes a hydrophobically modified alkali-soluble rheology modifier.

In an embodiment, the pigment is mixed with the dispersing agent to exhibit a DOP ratio between 0.5 and 1.5. Mechanical crush energy is applied to the pre-mixture to de-aggregate pigment particles. The pre-mixture is then mixed with the solvent, binder and rheology modifier to form the paint.

In different embodiments that paint may be used to provide a coating to cover or obscure in an aesthetic manner some type of IR body or device. For example, the paint may be applied to a base having a transmissivity that spans the NIR and SWIR bands to cover transmitting and receiving units for an IR sensor. Other applications of the paint formulation in which good absorption in the visible band and high transmission in the NIR and SWIR bands are contemplated by this disclosure.

These and other features and advantages of this disclosure will be apparent to those skilled in the art from the following detailed description of preferred embodiments, taken together with the accompanying drawings, in which:

### BRIEF DESCRIPTION OF THE DRAWINGS

FIG. 1 is a drawing of a water-based acrylic latex coating that absorbs in the visible band and is transmissive in the NIR and SWIR bands;

FIG. 2 is a plot of transmissivity vs wavelength illustrating an embodiment of required maximum transmissivity in the visible band and minimum transmissivities in the NIR and SWIR bands;

FIG. 3 is a Table of the design space variables of the pigment weight %, DOP ratio and coating thickness to achieve specified transmissivity in the Visible and NIR/SWIR bands;

FIG. 4 is an illustration of an embodiment of a process for pre-mixing the NIR/SWIR transparent pigment with a dispersing agent to provide a low concentration of highly dispersed pigment;

FIG. 5 is an illustration of an embodiment for combining the pre-mix of the pigment and dispersing agent with the water-based acrylic latex binder and rheological modifier to form a paint that cures at ambient temperature and pressure to form the coating;

FIG. 6 is a Table of an exemplary formulation of the water-based acrylic latex paint;

FIG. 7 is a plot of transmissivity vs wavelength for the exemplary formulation of the paint at different coating thicknesses; and

FIG. 8 is an embodiment of a cover for IR transmitting and receiving units that transmits in the NIR and SWIR bands and produces a black color.

### DETAILED DESCRIPTION

The present disclosure provides a water-based acrylic latex paint that when applied dries to form a coating that absorbs in the visible band to produce a visible color (e.g., black) and is transmissive in the NIR and SWIR bands.

A commercially available acrylic paint is a fast-drying paint made of pigment suspended in acrylic polymer emulsion and plasticizers, silicon oils, defoamers, stabilizers, or metal soaps. Most acrylic paints are water-based but become water resistant when dry. Water-based acrylic paints are used as latex house paints, as latex is the technical term for a suspension of polymer microparticles in water. An inorganic or organic pigment is a colorized material that is completely or nearly insoluble in water. Color of pigments arises because they absorb only certain wavelengths of visible light. The bonding properties of the material determine the wavelength and efficiency of light absorption. Absorption over the entire visible band produces a black color. These commercially available paints also absorb light in the NIR and SWIR bands. A dispersing agent is a substance, typically a surfactant, that is added to a suspension of pigment particles in the solvent (water) to improve the separation of the particles and to prevent their settling or clumping. A DOP ratio of approximately 0.2 is typical for acrylic paints. A high concentration of pigment (e.g., at least 20% by weight) is required to achieve maximum coverage and absorption of visible light. A rheology modifier is typically added to the mix to form a non-Newtonian fluid that provides “associative thickening” so that when the paint is applied to form a coating it does not “bead up” but remains as a uniform thin coating. A defoamer is a chemical additive the reduces surface tension to prevent the formation of bubbles.

To provide a water-based acrylic latex paint that is highly absorptive in the visible band and highly transmissive in the NIR and SWIR bands without sacrificing the formability characteristics (e.g., not runny, not sag, clean film, no brush strokes etc.) and ambient drying characteristics requires more than just substitution of a NIR/SWIR transparent pigment for a standard color pigment.

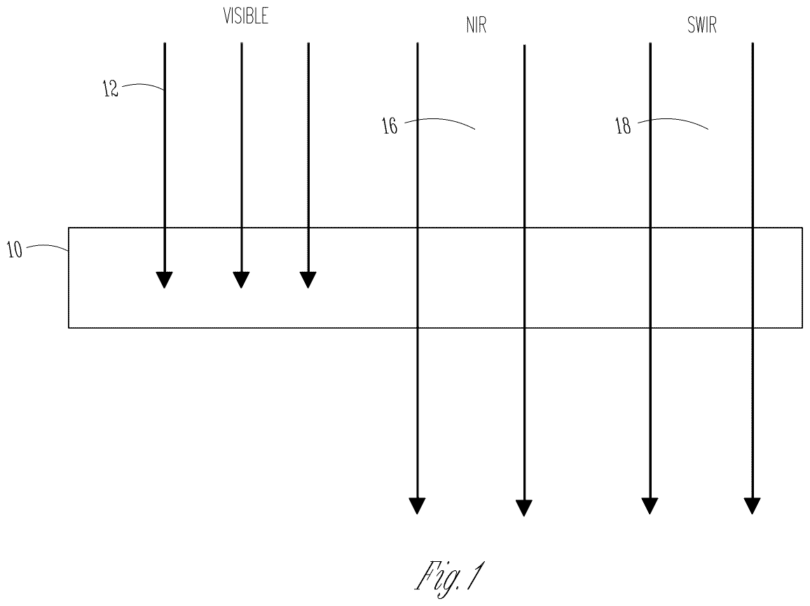

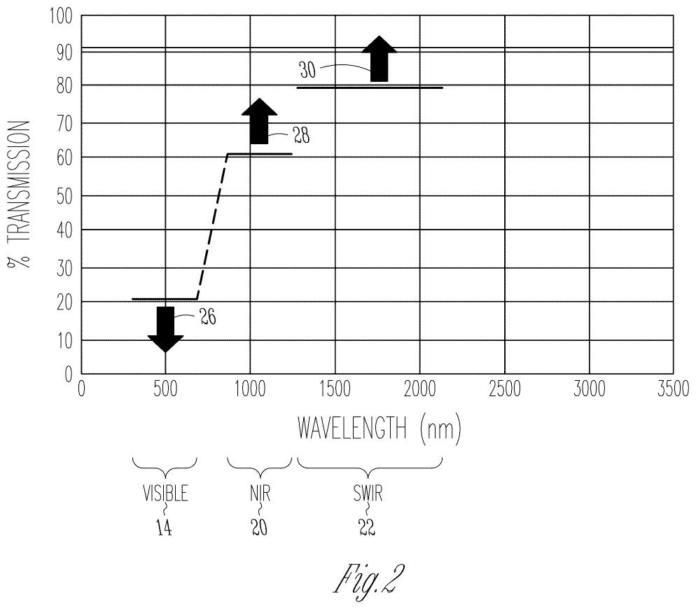

Referring now to FIGS. 1 and 2, a coating 10 is formed by application of a water-based acrylic latex paint that dries at ambient temperature (approximately 10- to 35 C) and ambient pressure (approximately 29 to 31 inches of mercury). Coating 10 is designed to absorb rays 12 in the visible band 14 to produce a color (e.g., black) and to transmit rays 16 and 18 in the NIR and SWIR bands 20 and 22, respectively. In an embodiment, on-average the transmittance 26 over the visible band 14 is less than 20% and on-average the transmittances 28 and 30 over the NIR and SWIR bands 20 and 22 are at least 60% and 80%, respectively. Preferably, the transmittance specification is satisfied at each wavelength within the bands. If additional pigments are added to produce a non-black color, the transmittance specifications in the NIR and SWIR bands may be lower. For example, transmittance in the NIR may be at least 50% and transmittance in the SWIR may be at least 70% on average.

The formulation of the water-based acrylic latex paint that produces coating 10 to meet such transmittance specifications requires a pigment that has a low concentration (e.g., <5.2% wt.) in the dried coating and is highly dispersed (e.g., pigment particle diameter <0.8 microns) throughout the coating. If the concentration is too high, the transmittance in the NIR and SWIR bands will not meet the specification. If the pigment is not adequately dispersed, the absorption in the visible band will suffer and the specification will not be met.

To achieve this, a formulation of the water-based acrylic latex paint includes an acrylic latex binder, a solvent of water, a pigment, a dispersing agent, a rheology modifier and a defoamer. The binder and dispersive agent components being transmissive in the NIR and SWIR bands (e.g., >90% on average). The pigment has a cut-off wavelength that lies between the visible and NIR bands. Below the cut-off the pigment is absorptive and above the cut-off the pigment is transmissive.

The mixture has a dispersant-over-pigment (DOP) ratio between 0.5 and 1.5 and more typically between 0.8 and 1.5. This ensures the low concentration of pigment in the coating. To ensure that the pigment is highly disperse throughout the coating, the dispersing agent preferably has a molecular weight higher than 2,000 grams per mole. Furthermore, dispersing agents that have a block co-polymer including an amine-functional block to anchor onto the pigment have better absorption characteristics in the visible band than lignosulfonate-based dispersing agents.

The rheology modifier is suitably selected to provide non-Newtonian fluid that provides “associative thickening” to the formulation. A hydrophobically modified alkali-soluble rheology modifier is a good choice for sag resistance as it forms networks through inter-connections of, for example, hydrophobic acrylic ester units to provide the associative thickening.

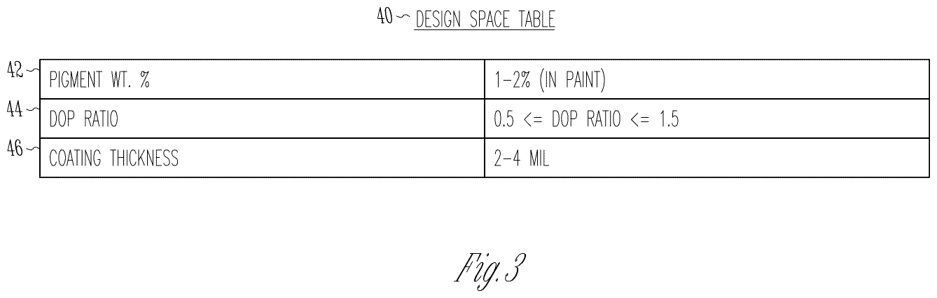

Referring now to FIG. 3, the variables of the paint formulation that determine absorption in the visible band and transmission in the NIR and SWIR bands in the resulting film are depicted in a design space Table 40 that includes a pigment weight percentage 42 between 1-2% by weight in the paint formulation (approximately 2.6-5.2% by weight in the dried coating), a DOP ratio 44 between 0.5 and 1.5 and a coating thickness 46 between 2 and 4 mil. More typically, the DOP ratio is between 0.8 and 1.5. These three variables and their respective ranges define the design space for the paint formulation to meet different specifications for transmittance in the Visible and NIR/SWIR bands. As compared to commercial latex paint (typical DOP ratio of 0.2) and the cool black coating latex paint (DOP ratio less than 0.1), the DOP ratio for our formulation is at least 0.5 and more typically at least 0.8, which is critical to achieve both the visible band absorption and NIR/SWIR band transmission. Furthermore, the pigment weight percentage of 1-2% is considerably less than the 5% pigment (not including the talcum extender pigment) in the cool coating and far less than the 20% pigment in commercial latex paints. The coating thickness of 2-4 mil is also less than the cool black coating thickness of 4-6 mil. The requirements for our formulation to meet the transmission specifications in both the visible and NIR/SWIR bands are more stringent and thus require a different and more precise design space.

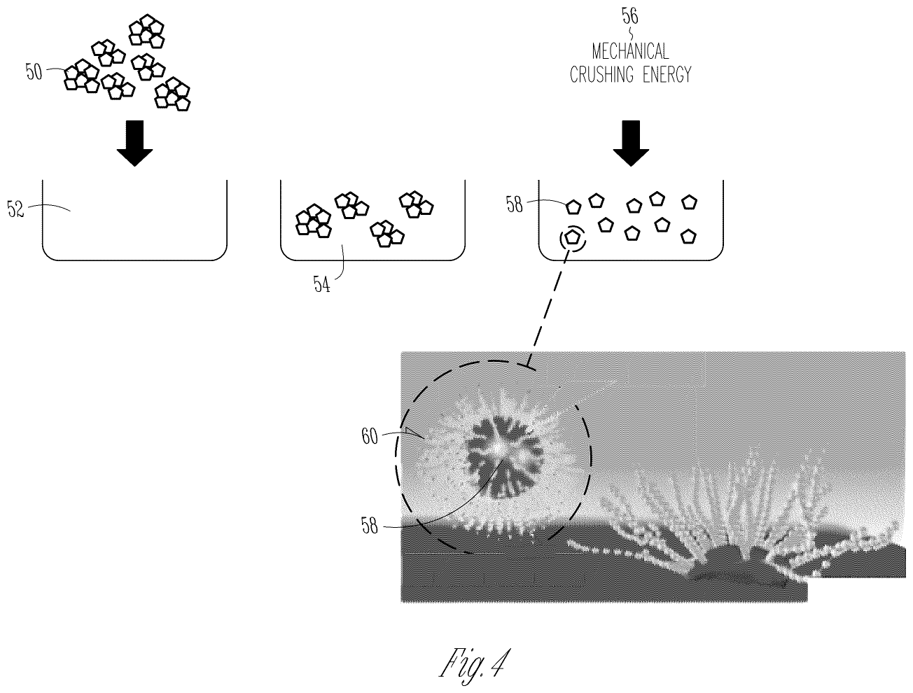

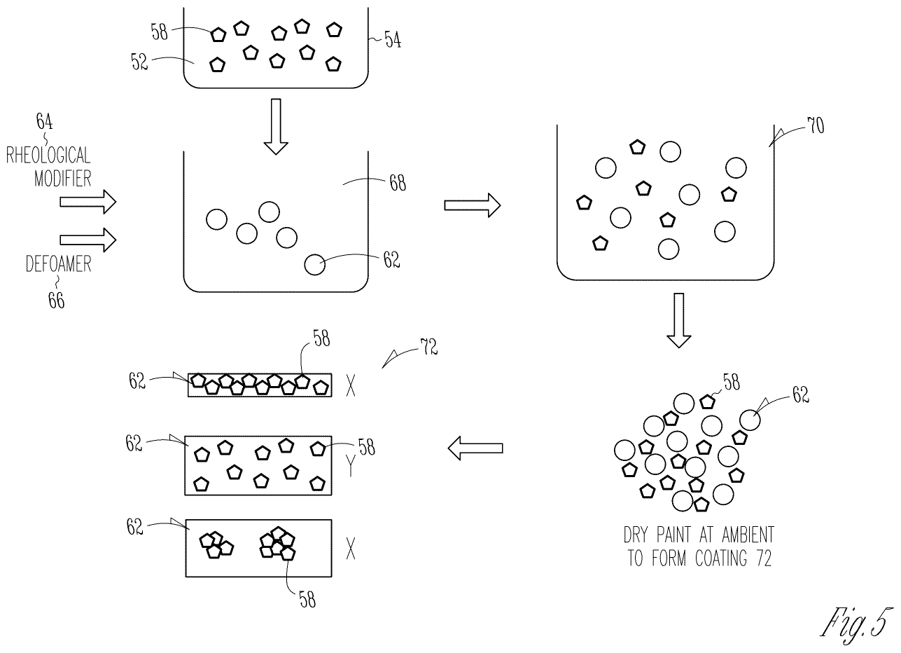

Referring now to FIGS. 4 and 5, a dry pigment powder 50 is mixed with a dispersing agent 52 to form a pre-mixture 54. A mechanical crush force 56 is applied such as through a ball milling process to pre-mixture 54 to de-aggregate the pigment particles 58. As previously mentioned, a preferred dispersing agent has a block co-polymer including an amine-function block or “tentacle” 60 to anchor onto the pigment particle 58. The tentacles form non-polar bonds to the pigment and polar bonds to the water molecules. The tentacles have an affinity for water, which serves to suspend the pigment particles even though the particles are themselves insoluble.

As shown in FIG. 5, pre-mixture 54 is then mixed with an acrylic latex binder 62, a rheological modifier 64, a defoamer 66 and a solvent (water) 68 to form a water-based acrylic latex paint 70. Paint 70 is applied and dries at ambient temperature and pressure to form a coating 72 in which the pigment particles 58 are suspended in the fused latex binder particles 62. Given the proper combination of the DOP ratio, pigment weight percentage, coating thickness and dispersing agent, the pigment particles 58 will exhibit the desired low concentration and be highly dispersed throughout coating 72 as shown in the middle depiction. If the variables and dispersing agent are not properly selected, the concentration of pigment particles 58 may be too high and insufficiently dispersed (top depiction) producing insufficient transmission in the NIR/SWIR bands or the pigment particles 58 may be clumped together within the coating (bottom depiction) producing insufficient absorption in the visible band.

Each ingredient in the formulation was identified based on maximizing transparency in the NIR and SWIR bands while minimizing transparency in the visible band. However, upon blending, it was noted that drastically different films were being made, in terms of film formation as well as end-properties, depending on other factors that had to be controlled. Achieving the desired end-properties in the formed film is predicated on 1) the spectral properties of each ingredient in the formulation (i.e., the “component level”; 2) their dispersion in the cast layer (i.e., the “interaction level”); and 3) the structure that all ingredients in aggregate form within the coating (i.e., the “system level”).

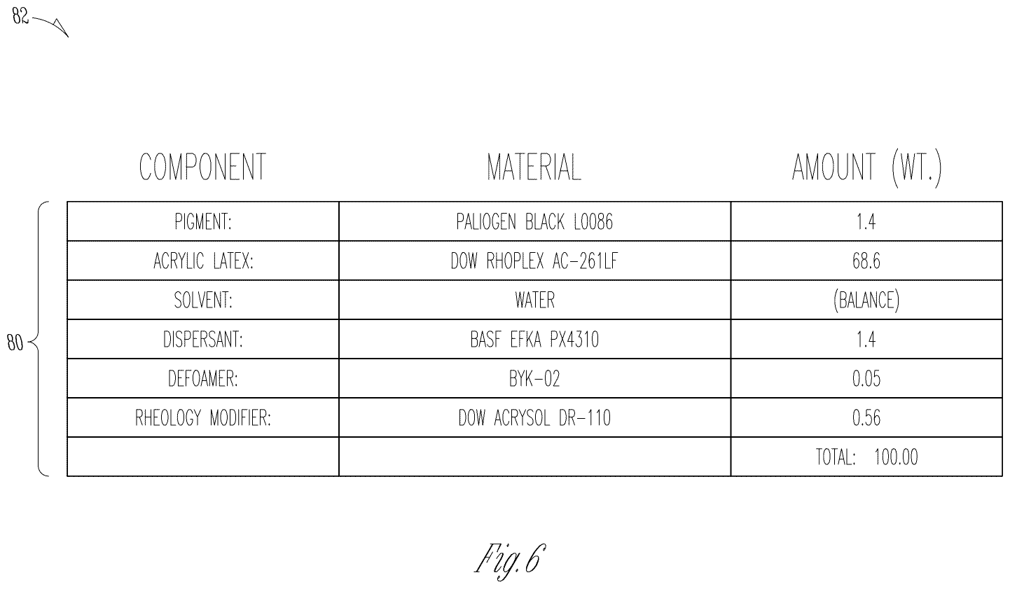

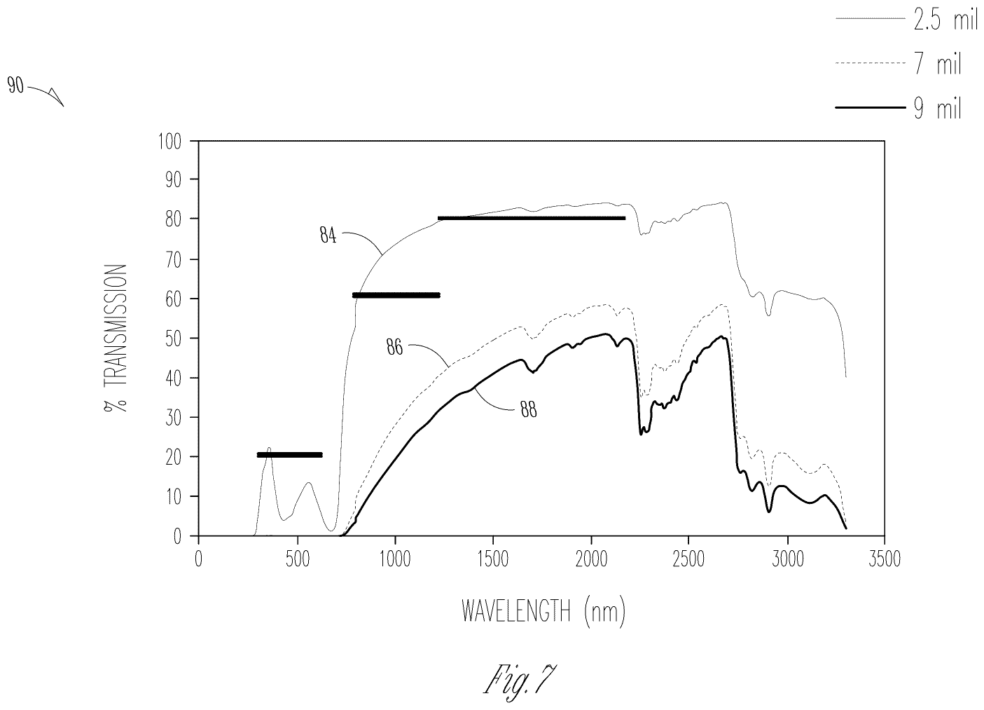

Referring now to FIGS. 6 and 7, an exemplary formulation of a water-based acrylic latex paint 80 with a black color is depicted in Table 82 and its transmissivities 84, 86 and 88 for coating thickness of 2.5, 7 and 9 mil are depicted in plot 90. The transmissivities were measured for a coating deposited on a glass slide, which has some absorption in the high end of the SWIR band. The pigment is Paliogen® Black L 0096 produced by BASF SE, which has a cut-off wavelength at 780 nm. The acrylic latex binder is RHOPLEX™ AC-261LF produced by Dow Inc., which is an all-acrylic emulsion polymer for latex floor paints. Testing demonstrated that this binder >90% over the Visible and NIR/SWIR bands. The solvent is water. The dispersing agent is EKFA® PX 4310 produced by BASF SE, which is a co-polymer that contains an amine-function block. The defoamer is BYK-024 produced by BYK USA Inc. The rheology modifier is ACRYSOLTM® DR-110 produced by DOW Inc., which is a hydrophobically modified alkali-soluble rheology modifier. The majority of the paint by weight percentage is constituted by the acrylic latex binder, approximately 68.6%, of which approximately half is itself water. The rheology modifier is 0.56% wt. and the defoamer is just 0.05% wt. The pigment and dispersing agent are in equal amounts at 1.4% wt. yielding a DOP ratio of 1, which helps maintain a low concentration of pigment at very high dispersion; this in turn helps in preventing agglomeration or/and non-uniform pigment distribution which would result in low absorption at the visible range. In other words, with a relatively low amount of pigment we achieve maximum absorption at the visible but high transmission at SWIR. The balance is made up of water.

As shown in plot 90, the transmissivity 84 for a 2.5 mil coating is on-average less than 20% in the visible band, greater than 60% in the NIR band and greater than 80% in the SWIR band. The transmissivity satisfies the specifications at virtually every wavelength in each of the bands. Note, the drastic reduction in transmissivity at approximately 2300 nm is caused by the acrylic latex binder. Note, the transmissivities 86 and 88 for 7 and 9 mil coatings are highly absorptive in the visible band because of the additional thickness. However, the transmissivity fails to meet spec in the NIR/SWIR bands.

In different embodiments that paint may be used to provide a coating to cover or obscure in an aesthetic manner some type of IR body or device. For example, the paint may be applied to a base having a transmissivity that spans the NIR and SWIR bands to cover transmitting and receiving units for an IR sensor. Other applications of the paint formulation in which good absorption in the visible band and high transmission in the NIR and SWIR bands are contemplated by this disclosure.

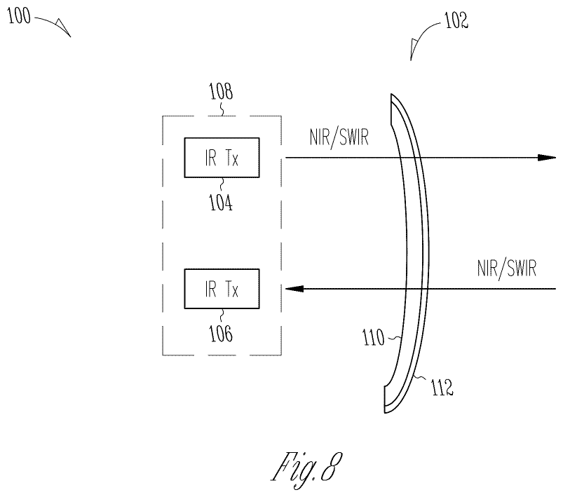

Referring now to FIG. 8, an infrared transmissive product 100 includes a body 102 configured to cover a transmitting unit 104 and a receiving unit 106 for NIR and SWIR rays in an IR sensor 108. Body 102 includes a base 110 having a transmissivity that spans the NIR and SWIR bands and a coating 112 between 2 and 4 mil thick on a rear or front surface of the base. Coating layer 112 comprises a water-based acrylic latex paint including a mixture of a de-aggregated pigment of 1-2% by weight and a dispersing agent that are transmissive in the NIR and SWIR bands. When dried the pigment constitutes about 2.6-5.2 wt. % of the coating. The mixture has a dispersant-over-pigment (DOP) weight ratio of between 0.5 and 1.5, and a rheology modifier. The paint cures at ambient temperature and pressure to form the coating in which the pigment has a low concentration and is highly dispersed throughout to absorb in the visible band to produce a color and is transmissive in the NIR and SWIR bands.

While several illustrative embodiments have been shown and described, numerous variations and alternate embodiments will occur to those skilled in the art. Such variations and alternate embodiments are contemplated, and can be made without departing from the spirit and scope of the invention as defined in the appended claims.

We claim:

1. A water-based acrylic latex paint, comprising:
an acrylic latex binder that is transmissive in the NIR and SWIR bands;
a solvent of water;
a mixture of a de-aggregated pigment that is transmissive in the NIR and SWIR bands and a dispersing agent that is transmissive in the NIR and SWIR bands, said mixture having a dispersant-over-pigment (DOP) ratio between 0.5 and 1.5; and
a rheology modifier,
wherein the paint dries at ambient temperature and pressure to form a coating in which the pigment has a low concentration and is highly dispersed throughout to absorb in the visible band to produce a color and is transmissive in the NIR and SWIR bands.

2. The water-based acrylic latex paint of claim 1, wherein the visible band spans 400-700 nm, the NIR band spans 800-1300 nm and the SWIR band spans 1300-2200 nm.

3. The water-based acrylic latex paint of claim 2, wherein the coating has an average transmittance of less than 20% transmissive over the visible band and average transmittances of greater than 60% transmissive over the NIR band and greater than 80% transmissive over the SWIR band.

4. The water-based acrylic latex paint of claim 3, wherein the transmissivity in the Visible, NIR and SWIR bands is controlled by the DOP ratio, a weight percentage of the pigment between 1-2% in the paint and a thickness of the coating between 2 and 4 mil.

5. The water-based acrylic latex paint of claim 4, wherein the DOP ratio is between 0.8 and 1.5.

6. The water-based acrylic latex paint of claim 4, wherein the binder is RHOPLEX™ AC-261F, the pigment is Paliogen® Black L0086 and the dispersing agent is EFKA® PX4310, wherein the DOP ratio is approximately 1.

7. The water-based acrylic latex paint of claim 1, wherein the transmissivity in the Visible, NIR and SWIR bands is controlled by the DOP ratio, a weight percentage of the pigment between 1-2% in the paint and a thickness of the coating between 2 and 4 mil.

8. The water-based acrylic latex paint of claim 7, wherein the DOP ratio is approximately 1.

9. The water-based acrylic latex paint of claim 1, wherein the binder and the dispersing agent each have an average transmissivity of at least 90% over the NIR and SWIR bands.

10. The water-based acrylic latex paint of claim 1, wherein the dispersing agent has a molecular weight of more than 2,000 grams per mole.

11. The water-based acrylic latex paint of claim 1, wherein the dispersing agent is an acrylate-based block co-polymer including an amine-functional block to anchor onto the pigment.

12. The water-based acrylic latex paint of claim 1, wherein the rheology modifier provides associative thickening to the paint.

13. The water-based acrylic latex paint of claim 12, wherein the rheology modifier is a hydrophobically modified alkali-soluble rheology modifier.

14. The water-based acrylic latex paint of claim 1, wherein the pigment has a cut-off wavelength between the visible and NIR bands.

15. The water-based acrylic latex paint of claim 1, wherein the pigment produces a black color.

16. The water-based acrylic latex paint of claim 1, further comprising a second pigment to produce a non-black color.

17. A process of formulating a water-based acrylic latex paint, the process comprising:
pre-mixing a pigment that is transmissive in the NIR and SWIR bands with a dispersing agent that is transmissive in the NIR and SWIR bands, said mixture having a dispersant-over-pigment (DOP) ratio between 0.5 and 1.5;
applying mechanical crushing energy to de-aggregate the pigment particles; and
mixing with a solvent comprising water, an acrylic latex binder that is transmissive in the NIR and SWIR bands and a rheology modifier;
wherein the paint dries at ambient temperature and pressure to form a coating in which the pigment has a low concentration and is highly dispersed throughout to absorb in the visible band to produce a color and is transmissive in the NIR and SWIR bands.

18. The process of claim 16, wherein the transmissivity in the Visible, NIR and SWIR bands is controlled by the DOP ratio, a weight percentage of the pigment between 1-2% in the paint and a thickness of the coating between 2 and 4 mil.

19. The process of claim 16, wherein the dispersing agent is an acrylate-based block co-polymer including an amine-functional block with a molecular weight more than 2,000 grams per mol.

20. An infrared transmissive product, comprising:
a body configured to cover a transmitting unit and a receiving unit for NIR and SWIR rays in an IR sensor, wherein the body includes
a base having a transmissivity that spans the NIR and SWIR bands; and
a coating between 2 and 4 mil thick on a rear or front surface of the base, the coating layer comprising a water-based acrylic latex paint including a mixture of a de-aggregated pigment of 2.6-5.2% by weight and a dispersing agent that are transmissive in the NIR and SWIR bands, said mixture having a dispersant-over-pigment (DOP) weight ratio of between 0.5 and 1.5, and a rheology modifier,
wherein the paint cures at ambient temperature and pressure to form the coating in which the pigment has a low concentration and is highly dispersed throughout to absorb in the visible band to produce a color and is transmissive in the NIR and SWIR bands.
